(19) United States
(12) Patent Application Publication
(10) Pub. No.: US 2013/0334000 A1
(43) Pub. Date: Dec. 19, 2013

(54) CONNECTING DEVICE AND GEARBOX FOR A VEHICLE DRIVE TRAIN AS WELL AS METHOD FOR OPERATING SUCH A CONNECTING DEVICE

(71) Applicant: ZF FRIEDRICHSHAFEN AG, Friedrichshafen (DE)

(72) Inventors: Georg GERAUER, Neuhaus (DE); Alois BOCK, Hutthurm (DE)

(73) Assignee: ZF Friedrichshafen AG, Friedrichshafen (DE)

(21) Appl. No.: 13/889,591

(22) Filed: May 8, 2013

(30) Foreign Application Priority Data
Jun. 19, 2012 (DE) 10 2012 210 287.6

(51) Int. Cl. F16D 11/14

(52) U.S. Cl. CPC F16D 11/14
USPC 192/69.7

(57) ABSTRACT

A connecting device for connecting first and second shafts in a rotationally fixed manner. The connecting device has a connecting element with form-locking elements that axially moves between a first axial position, to form lock the shaft via the form-locking elements, and a second axial position, to release the form lock. An actuator, when electrically energized, causes movement of the connecting element between the first and the second position. The locking elements are disposed in axially spaced first rows such that, in the first position, these rows engage with corresponding second rows of locking elements of the first shaft to achieve a form lock and couple the first and second shafts, and, in the second position, the first rows disengage from the corresponding second rows of form-locking elements of the first shaft to respectively release the first and second shafts and permit relative rotation therebetween.

This application claims priority from German patent application serial no. 10 2012 210 287.6 filed Jun. 19, 2012.

### FIELD OF THE INVENTION

The invention relates to a connecting device for a vehicle drive train for the rotationally fixed connection of a first and a second shaft that are rotatable relative to each other. Additionally the invention relates to transmission for a vehicle drive train having such a connecting device, and a method for actuating such a connecting device.

### BACKGROUND OF THE INVENTION

Such a connecting device serves in a vehicle drive train particularly for connecting two halves of an all-wheel shaft or a wheel drive shaft, also called wheel shafts or side shafts. In a vehicle drive train having several drivable drive axles, this connecting device allows, for example, switching between an all-wheel operating mode (also called all-wheel mode, 4WD mode, AWD mode or similar), in which several or all of the drive axles of the vehicle drive train are driven, to a two wheel operating mode (2 wheel mode, 2WD mode or similar) in which fewer or only one of the drive axles of the vehicle drive train are driven, and vice versa.

FIG. 2 of the document DE 198 37 417 A1 discloses a connecting device of a vehicle drive train for the rotationally fixed connection of two shafts, that is, an automatic coupling for connecting a front axle to a wheel spindle. For this purpose, the clutch has an electromagnet by means of which a coupling ring is axially movable between two axial positions. In the first axial position, the wheel spindle and the front axle are connected, rotationally fixed, by means of the coupling ring, whereas in the second axial position the wheel spindle and the front axle are no longer rotationally fixed together. For this purpose, the coupling ring has a row of tooth recesses in a radial inner direction (inside) which always engage in a row of corresponding outer tooth recesses of the front axle. If the coupling ring is located in the first axial position, the row of tooth recesses of the coupling ring additionally engages in a row of corresponding outer tooth recesses of the wheel spindle, thereby producing the rotationally fixed connection between the front axle and the wheel spindle. In contrast, when the coupling ring is located in the second axial position, the row of tooth recesses of the coupling ring is released from the row of corresponding tooth recesses of the wheel spindle. Here, the outward movement of the coupling ring into the first axial position is caused by a spring, and the return movement into the second axial position is caused by the electromagnet.

With such a rotationally fixed connection by means of tooth recesses engaging in each other, the transferable torque is determined by, among other things, the axial overlap of the tooth recesses. In the case of a large overlap, the surface for force transmission per tooth recess pair is greater, which reduces the surface pressure on each tooth recess. Additionally, more material is available for bearing the force, or further transmitting the force with torque transmission between the shafts, whereby the material loading is reduced within each tooth recess.

For transmitting a large torque, the device according to the document DE 198 37 417 A1, thus the coupling ring, must travel a long axial distance in order to create a large overlap of the tooth recesses. For releasing the rotationally fixed connection, the electromagnet must move the coupling ring back again via the same path using magnetic attraction. The range of the magnetic attraction is however very limited, whereby an arbitrarily wide displacement path is not possible. As a consequence, the torque that can be transmitted with such a device is strictly limited.

### SUMMARY OF THE INVENTION

The problem addressed by the invention is therefore to provide a connecting device and a transmission for a vehicle drive train for the rotationally fixed connection of a first and a second shaft that are rotatable relative to each other, which has improved torque transfer capability.

Accordingly, the invention relates to a connecting device, particularly for a vehicle drive train for the rotationally fixed connection of a first and a second shaft that are rotatable relative to each other. Here, a vehicle drive train is understood to be particularly a drive train of a vehicle by means of which drive torque for driving the vehicle can be mechanically transmitted from a drive engine, for example an electric motor and/or an internal combustion engine, to drive means, for example vehicle wheels, vehicle chains or vehicle screws.

The connecting device has an axially movable connecting element having a form-locking element, which in a first axial position produces a form lock between the first and second shaft by means of the form-locking elements, and in a second axial position releases the form lock. As a result, it is possible in the first axial position to transmit torque from the first to the second shaft via the form-locking elements. Axially movable in this context means in particular linearly movable or transversely movable, that is, at least along a straight line. Such form-locking elements are particularly components by means of which a form lock can be produced with corresponding, for example, complementary formed further form-locking elements, such as claws, teeth or pins. A second form-locking element corresponding to a first form-locking element is designed particularly so that the element can be releasably form locked with the first form-locking element, that is, due to an appropriate design (spline profile, polygon profile, claws, teeth, pins, etc). The form-locking elements can be formed integrally with the connecting element, or form separate components, which are firmly connected together, for example, plugged, screwed, shrunken, bonded, etc.

The connecting device also has an electromagnetic actuator, which, when energized, causes movement of the connecting element between the first and the second axial position. This movement occurs particularly using magnetic attraction or repulsion of a (magnetic) anchor connected to the connecting element. The connecting element here can itself also serve as an anchor, or be implemented integrally with the anchor. In the case of an electromagnetic actuator, this is particularly one or more electromagnets. Electromagnets, when electrically energized, produce a magnetic field by means of which the anchor(s) can be moved.

According to the invention, the form-locking elements are disposed in the axial movement direction of the connecting element in several first rows spaced apart from each other. Thus, at least two first rows are disposed in the direction of the axial movement direction of the connecting element spaced apart behind one another.

The arrangement of the first rows of form-locking elements is such that in the first axial position, these several first rows are form locked with at least one corresponding second row of form-locking elements of the first shaft, whereby the form lock is produced between the first and the second shaft. In other words, the first shaft, in addition to the connecting element, also has form-locking elements, and particularly several second rows (at least two), wherein at least one of these second rows interacts in a form-locking manner with, respectively, a corresponding first row of connecting elements, when the connecting element is located in the first axial position, whereby the form lock is produced between the first and the second shaft.

Additionally, the arrangement of the first row of form-locking elements is such that, in the second axial position, the several first rows with the respectively corresponding second row of form-locking elements of the first shaft are released, whereby the form lock is released between the first and the second shaft. In other words, the first rows of form-locking elements are also disposed such that they are disengaged from the second rows of form-locking elements, that is, no longer form locked, when the connecting element is located in the second axial position.

Basically, the displacement element is implemented such that it is axially movable. The electromagnetic actuator can be implemented particularly as a linear actuator, which moves directly axially. This allows a simple mechanical design of the actuator and the connecting device. The connecting element can however, if necessary, also be disposed such that it is additionally rotatable with respect to the first and/or second shaft. Particularly then, by using a guide device, the connecting element can be guided, so that upon rotation with respect to the first or the second shaft, the element is simultaneously moved axially between the first and the second axial position. This can occur using a slotted guide or a cam, along which the connecting element runs. Here, the electromagnetic actuator is implemented particularly such that it creates rotational movement, which is transferred to the connecting element.

The connecting element and the second shaft are particularly then connected together, rotationally fixed, at least when the connecting element is located in the first position. This can occur using known, rotationally fixed and possibly simultaneously axially movable connection means, for instance polygon profiles, spline profiles, pins, teeth, claws, etc. The rotationally fixed connection can also be releasable or released, when the connecting element is located in the second axial position, particularly analogous to the connection of the connecting elements with the first shaft via the first and second rows of form-locking elements. In this case, the connecting element has additional first rows of form-locking elements spaced apart in the axial movement direction of the connecting element, that are disposed such that in the first axial position these further first rows are form locked, respectively, with at least one corresponding further second row of form-locking elements of the second shaft, whereby the form lock is produced between the first and the second shaft, and in the second axial position these several first rows, with the respectively corresponding further second rows of form-locking elements of the second shaft, are released, whereby the form lock between the first and the second shaft is released. As an alternative to this, the connecting element is connected, fixed in location, to the second shaft, for example, in that the connecting element and the second shaft are formed integrally or are rigidly connected together. In this case, the second shaft also moves with an axial movement of the connecting element. Because this is not always desirable, the second shaft and the connecting element can also be connected together, rotationally fixed, however simultaneously axially displaceable from each other, which can be achieved using known form-locking elements, such as a spline profile, polygon profile, pins, teeth, claws, etc.

The connecting device acts in the sense of a coupling if the first and the second shaft can both be rotated. If one of the two shafts is fixed, particularly with respect to the housing, and the other shaft can be rotated with respect thereto, then the connecting device acts in the manner of a brake.

In a further development of the connecting device, the electromagnetic actuator and the connecting element are implemented as a ring and disposed coaxially to the first and/or second shaft. The connecting element is disposed at least partially radially within the electromagnetic actuator, and the first rows of form-locking elements are disposed radially within the connecting element. This results in a very compact design of the connecting element, particularly in the axial direction, because the individual components are disposed radially within each other. Here, “radial” specifies a direction which is perpendicular to the common axis, to which the named components are coaxially disposed. The actuator forms a ring surrounding the connecting element, which in turn forms a ring around the first row of form-locking elements.

In a further development of the connecting device, the connecting device additionally has an anchor element, which can be magnetically moved, in particular displaced, by energizing the electromagnetic actuator, and which is rotationally connected via an axial bearing to the connecting element, and in such a manner that a movement of the anchor element causes an axial movement of the connecting element between the first and the second axial position. Thus, the rotation of the connecting element is not transferred to the anchor element, whereby it is not necessary to balance the anchor. Here, the anchor element is implemented, rotationally fixed, particularly with respect to the electromagnetic actuator. This guarantees that the anchor element also does not actually rotate with respect to the actuator, and possibly lead to undesired oscillations in the connecting device.

In another further development of the connecting device, the connecting device has an anchor element which can be magnetically displaced due to energizing the electromagnetic actuator, and which is fixed in place, connected to the connecting element. Thus, a displacement of the anchor element causes the movement of the connecting element between the first and the second axial position. Because the connecting element and the anchor element are fixed in place, connected together, and are implemented integrally for example, this embodiment of the connecting device is mechanically simpler to construct. Depending on the rotation attained by the connecting element, it can be necessary to balance the anchor.

In a further development, this connecting device has a magnetic yoke, which is fixed in position, connected to the electromagnetic actuator, and surrounds the electromagnetic actuator, at least on a first part. Alternatively or additionally, the anchor element is implemented such that it encloses at least a second part of the electromagnet. In the region of this enclosure, the electromagnetic anchor is better protected by the magnetic yoke, or the anchor element, against external mechanical influences. Additionally, the enclosure causes an improved further transmission of the magnetic flux into the electromagnetic anchor. The flux is generated when the actuator is energized, in order to cause the movement of the anchor element and the connecting element. Thus, due to the at least partial enclosure, the magnetic field can also be better utilized for moving the connecting element. Additionally, the magnetic shielding for the actuator is improved.

In a further development thereof, the magnetic yoke and the anchor element are implemented such that these at least (completely) enclose the electromagnet, when the connecting element is located in the second axial position. Thus, the magnetic flux of the actuator enclosed in a circuit in the first or second axial position. As a result, the range of axial movement of the actuator is maximized. Additionally, the shielding of the surrounding area from the magnetic field of the actuator is improved, and also the actuator is better shielded from ambient magnetic fields.

In a further development thereof, the magnetic yoke or the anchor element, or alternatively, both, have at least one outlet opening through which fluid drainage is possible, particularly oil drainage, from the enclosure of the electromagnetic actuator, formed by the magnetic yoke and the anchor element. The opening can also be implemented particularly as a bore hole(s) in the magnetic yoke, or anchor element. Such an opening is especially advantageous, when the connecting device is disposed in a construction space filled at least partially with fluid, for example in a vehicle transmission filled with transmission oil. Accordingly, the fluid is particularly a lubricating means and/or cooling means within which the connecting device is disposed at least partially. With the movement of the connecting element due to the actuator, the fluid can rapidly escape from the enclosure consisting of the magnetic yoke and anchor element, or the anchor element can be moved in the fluid with a lower flow resistance, whereby the switching times of the connecting device are reduced.

In a further development, the connecting device has at least one permanent magnet, which is implemented so that it magnetically retains the anchor element when the connecting element is located in the first or second axial position. Thus, the connecting element is fixed in the axial position. Hereby, an electrical energizing of the electromagnetic actuator can be reduced or completely shut off, when the connecting element is located in the first or second axial position, and thus, the consumption of electrical energy is significantly reduced. Thus a currentless retaining function is realized. In other words, the connecting device is implemented such that it is bistable. In particular, the permanent magnet is disposed in the region of, for instance, a magnetic yoke of the connecting device so that at the installation position of the permanent magnet, the magnetic flux axis thereof largely corresponds to a magnetic flux axis of the electromagnetic actuator, when the actuator is energized. Here, a magnetic flux axis means particularly a local axis along which the magnetic flux of the magnetic field of the actuator, or permanent magnets, runs at this location, in, so to say, a local directional axis of the magnetic field lines. In this case, the installation location of the permanent magnets is selected so that, there, the magnetic flux of the actuator and permanent magnet runs substantially in parallel to each other when the actuator is electrically energized. As a result, it is possible to amplify the magnetic field generated by the actuator by means of the permanent magnets, which increases the movement range of the actuator. Additionally, by generating a magnetic field of the actuator in the opposing direction, by appropriately energizing (appropriate polarity), a temporary attenuation, or even cancellation of the magnetic field of the permanent magnets is possible, in order to release the anchor element from the permanent magnet, and thus to move the connecting element out of the first or second position, in which the permanent magnet fixes the connecting element.

In a further development hereof, the electromagnetic actuator is implemented, shaped as a ring, and the permanent magnet is disposed radially within or outside of the electromagnetic actuator. Hereby the above described currentless retaining function can be realized, with constant small axial extension of the connecting device.

A method for actuating the connecting device, which is implemented having the above described currentless retaining function, is as follows:

For axial outward movement of the connecting element into one of the first or second axial positions, the electromagnetic actuator is energized until the permanent magnet magnetically retains the anchor element in this axial position. The energizing occurs such that the magnetic field of the electromagnet in the range of the permanent magnet is aligned in the same direction as the magnetic field of the permanent magnet. This means that the polarity of the energizing is selected such that the magnetic field lines of the magnetic field of the actuator and of the permanent magnet point are substantially the same direction in the range of the permanent magnet. The magnetic force of the actuator is hereby amplified by the permanent magnets, and the range of movement of the actuator is increased.

For the axial return movement of the connecting element into the other of the first or the second axial positions, the electromagnetic actuator is then energized at least until the anchor element is released from the magnetic retention of the permanent magnet. Here, the energizing occurs such that the magnetic field of the electromagnet is aligned in the direction opposite to the magnetic field of the permanent magnet in the range of the permanent magnet. This means that the polarity of the energizing is selected such that the magnetic field lines of the magnetic field of the actuator and of the permanent magnet point are in substantially opposing directions in the range of the permanent magnet. The magnetic force and thus the retaining force of the permanent magnet is hereby reduced by the actuator or, due to sufficiently strong electrical energizing of the actuator, temporarily even completely compensated. The actual return movement of the connecting element can, naturally after sufficient reduction or cancellation of the retaining force, occur particularly induced by spring force, for example by means of the spring arrangement described in the following.

It is to be noted here that this method is also suitable for such connecting devices that only have a single first and second row of form-locking elements, and have the so-called currentless retaining function due to permanent magnets. Thus, the method would also be suitable, in principle, for a connecting device, which was, however, extended around the permanent magnet for the currentless retaining function.

In a further development of the connecting device, the electromagnetic actuator is implemented or disposed so that the actuator causes the outward movement of the connecting element into one of the first or second axial positions, and wherein a spring arrangement is provided which causes the return movement of the connecting element into the other respective first or second axial position. In other words, the outward movement of the connecting element out of the starting position into the first or second axial position occurs by means of the actuator, and the return movement out of this first or second axial position back into the starting position occurs by means of the spring arrangement. The starting position, in this case, is the other of the first or second axial positions. The spring arrangement is accordingly tensioned during the outward movement due to the actuator, and relaxed with the return movement. During the return movement, the actuator is simultaneously returned into the starting position thereof, in order to then be available again for the outward movement. In this context, tension means a buildup of potential (spring) energy, and relaxation means a dissipation of potential (spring) energy. Thus the actuator only needs to provide the outward movement, while the return movement occurs due to relaxing the spring arrangement, substantially without application of additional electrical energy. Thus, the actuator can be designed simply, and the connecting device requires less total electrical energy for actuation. Here, the spring arrangement can have any suitable design, such as one or more disk springs, helical springs, or wave springs. The spring arrangement is disposed particularly between two components of the connecting device, preferably a magnet anchor and a magnetic yoke. As a result, the design can be more compact, and can be implemented as a module.

In a further development hereof, the connecting element, the electromagnetic actuator, the anchor element, the magnetic yoke and the spring arrangement are implemented having a ring shape, and disposed coaxially to each other. Furthermore, the spring arrangement is disposed radially within the electromagnetic actuator, the connecting element is disposed radially within the spring arrangement, and the spring arrangement is disposed axially between the anchor element and the magnetic yoke. This nested construction allows for a very compact connecting device.

In a further development, the connecting device has a housing which encloses an outer periphery of the connecting device and at least a part of a first face side and a second face side, located opposite thereto, of the connecting device. Hereby the connecting device can be pre-installed as a one-piece module that must then simply be slid in or inserted into the final installation position as a whole, and connected electrically. Additionally, the housing provides mechanical protection, both in the installed state, as well as during transport as a separate, or installation-ready module. Because the housing encloses both face sides at least partially, the housing can completely absorb forces between the face sides within the connecting device, particularly spring forces of the spring arrangement for movement of the connecting element. Thus, it is not necessary that these forces be supported elaborately at the installation location.

The invention also relates to a transmission for a motor vehicle drive train, particularly a distributor transmission for such a motor vehicle drive train. The transmission has a first and a second shaft, which is rotatable in the distributor transmission, and a connecting device as described above. The transmission can be a gear shifting transmission, that is, a transmission which allows a change of transmission ratios between an input drive and an output drive, however the transmission concerns, particularly, a distributor transmission. A distributor transmission is, particularly, a transmission having an input drive and several output drives. Common terms for such distributor transmissions of a drive train are differential transmissions, axle differential transmission, differential, all-wheel distributor transmission, longitudinal or transverse distributor transmissions, etc. Using the device, an all-wheel or wheel drive shaft, also called a side shaft or wheel shaft, can easily be separated from the drive torque of a drive engine. The connecting device requires little installation space and is therefore very well suited for such a transmission for separating the all-wheel or wheel drive shafts.

### BRIEF DESCRIPTION OF THE DRAWINGS

The invention is explained in greater detail in the following with reference to schematic drawings, based on which further advantageous embodiments of the invention can be derived. They show:

FIG. 1 a sectional representation of a connecting device in the uncoupled state;

FIG. 2 a sectional representation of the connecting device from FIG. 1 in the coupled state;

FIG. 3 a sectional representation of a further development of the connecting device from FIGS. 1 and 2 in the decoupled state;

FIG. 4 a sectional representation of the connecting device from FIG. 3 in the coupled state;

FIG. 5 a top view of a vehicle drive train.

### DETAILED DESCRIPTION OF THE PREFERRED EMBODIMENTS

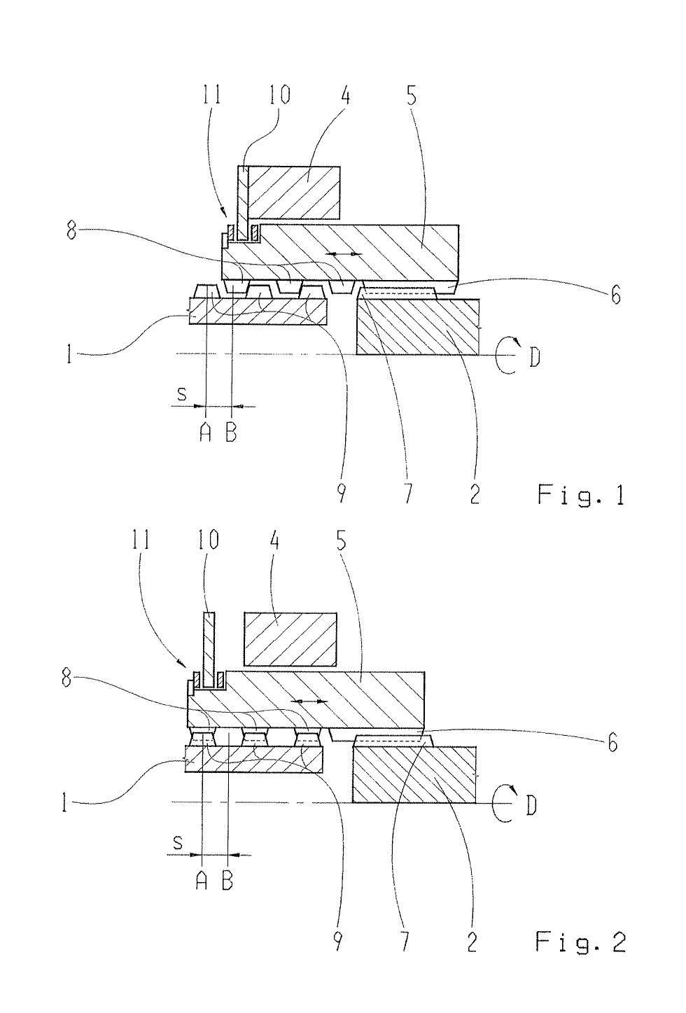

FIGS. 1 and 2 show schematic sectional representations of a single connecting device for connecting a first shaft 1 and a second shaft 2 in two different switching states. Here, in each case, the lower half of the connecting device is not shown for clarity. The same components in FIGS. 1 and 2 are assigned the same reference numbers. In FIG. 1, the shafts 1, 2 are released from each other using the connecting device, while in FIG. 2 the shafts are coupled together by means of the connecting device in order to transmit torque.

The shafts 1, 2 can rotate relative to each other and are disposed coaxially to each other about an axis of rotation D. Torque can be transmitted between the shafts 1, 2 as long as the connecting device couples the two shafts 1, 2 together. In the case shown in FIG. 1, the shafts 1, 2 are, however, released from each other using the connecting device. Thus, the shafts can rotate relative to each other, and no torque can be transmitted. The connecting device acts in the manner of a clutch, in the case where the two shafts 1, 2 can rotate. If one of the two shafts 1, 2 is fixed, for example with respect to a housing, not shown, relative to which however the other of the shafts 1, 2 can rotate, the connecting device acts in the manner of a brake.

The connecting device has an electromagnetic actuator 4. By means of the actuator, a connecting element 5 can move axially between a first axial position A and a second axial position B. The axial movement direction of the connecting element 5 is indicated by a double arrow, and runs parallel to the axis of rotation D. The actuator 4 and displacement element 5 are implemented in the shape of rings and are disposed coaxially to the axis of rotation D. The actuator 4 is located radially outside of the connecting element 5, and forms a ring enclosing this element. The connecting element additionally has an anchor element 10 which is magnetically, axially movable by the actuator. In the case shown, the anchor element 10 has a disk shape, although it can be designed differently, if suitable, and, for example, can at least partially envelope the actuator 4. The anchor element 10 transmits an axial movement to the connecting element 5. For this purpose, the anchor element 10 and the connecting element 5 are connected together rotatably via an axial bearing 11. Such an axial bearing 11 allows the transmission of an axial movement, or axial force, while simultaneously allowing rotational movement of the components involved; here components 5 and 10. In the case shown, the axial bearing 11 is implemented as two stop disks, which are disposed axially on both sides of the anchor element 10. Naturally, the bearing can also have different suitable designs, for example one or more roller bearings or a circumferential groove within which the anchor element 10 is guided. The anchor element 10 is preferably rotationally fixed with respect to the actuator 4 and is implemented such that it is axially movable (not shown more clearly in FIGS. 1 and 2). This prevents possible undesired rotation of the anchor element 10 with respect to the actuator 4.

Alternatively to the rotatable connection between anchor element 10 and the connecting element 5, these components 5, 10 can be connected together in a fixed manner. The anchor element 10 and connecting element 5 can then be implemented integrally. As a result, rotation of the connecting element 5 forces the rotation of anchor element 10 along with it. This allows a simpler mechanical design of the connecting device. However it can then be necessary to balance the anchor element 10 in order to prevent strong oscillations in the device when it rotates. This is not necessary with the example embodiment, shown in FIGS. 1 and 2, with a rotatable connection between the anchor element and the connecting element 10, 5.

In the case shown in FIGS. 1 and 2, the anchor element 10 and the actuator 4 are disposed such that the axial spacing thereof is minimal when the connecting element 5 is located in the second axial position B (FIG. 1), and that the axial spacing thereof is at a maximum when the connecting element 5 is located in the first axial position A (FIG. 2). Alternatively, the anchor element 10 and the actuator 4 can be disposed such that the axial spacing thereof is at a maximum when the connecting element 5 is located in the second axial position B, and that the axial spacing thereof is minimal when the connecting element 5 is located in the first axial position A. Which of these variants is more suitable depends on, among other things, the functioning of the actuator 4 in conjunction with the anchor element 10. The anchor element 10 and actuator 4 can be implemented such that the actuator 4 has a repelling effect on the anchor element 10. On the other hand, the anchor element 10 and the actuator 4 can be implemented such that the actuator 4 has an attractive effect on the anchor element 10. A repelling effect can be generated, for example, in that the anchor element 10 has one or more permanent magnets whose magnetic field is aligned counter to a magnetic field of the actuator 4. An attractive effect can be attained in that the anchor element 10 has one or more permanent magnets whose magnetic field is aligned to a magnetic field of the actuator 4. Or, an attractive effect can be attained in that the anchor element 10 has magnetizable material, for instance ferrite or another ferromagnetic material, which is attracted by the magnetic field of the actuator 4. In the latter case, the anchor can be produced very economically, because no permanent magnets are required in the anchor element 10. With the use of one/several permanent magnets in the anchor element 10, although this is more expensive, based on the polarity of the energizing, however, it is simple to choose between an attractive and a repelling function of the actuator 4 with respect to the anchor element 10, and the connecting element 5 can then be moved solely by means of the actuator 4.

In the case shown, the connecting element 5 is permanently connected, rotationally fixed, to the second shaft 2. For this purpose, the connecting element 5 and the second shaft 2 have corresponding form-locking elements 6, 7. In the example case shown, the connecting element 5 has, radially inside, at least one form-locking element 6 which is form locked to at least one correspondingly radially outside form-locking element 7 of the second shaft 2. Here, the form-locking elements 6, 7 are implemented such that the connecting element 5 can be moved axially, relative to the second shaft 2. It is clear that the connecting element 5 can also possibly have the form-locking element 7 radially outside, while then the second shaft 2 would have the corresponding form-locking element 8 radially inside. It is also conceivable to have form-locking elements disposed on each end surface, in the form of claws or pins. As an alternative to the form-locking elements 7, 8, the second shaft 2 and the connecting element 5 can also be implemented, securely connected together, or integrally. For this purpose then, the second shaft 2 is to be implemented, axially movable, analogous to the connecting element 5 shown in FIG. 1. The form-locking elements 6, 7 or the connection between the second shaft 2 and the connecting element 5 is designed so that using these, torque transmission occurs, or is possible, between the second shaft 2 and the connecting element 5—at least when the connecting element 5 is located in the first axial position A.

Additionally, the connecting element 5 has several first rows 8 of form-locking elements. These are disposed spaced axially apart from each other. The first shaft 1 has several second rows 9 of form-locking elements. These correspond to the first rows 8 of the connecting element 5. FIGS. 1 and 2 each show a total of 3 rows 8, 9; this number can however be adapted to the torque to be transmitted between the shafts 1, 2. A larger number of rows provides a greater torque transmission capability. The axial distance between the rows 8 corresponds to approximately double the shift path S between the first axial position A and the second axial position B. The same is true for the rows 9. However, a larger or smaller separation distance can also be selected. The axial spacing of the rows 8 corresponds to, or at least is nearly equal to, the axial spacing of the rows 9. As a result of this, there is uniform overlap of rows 8, 9 of form-locking elements in the coupled state of the connecting device, that is, when the connecting element 5 is located in the first axial position A. The rows 8, 9 are disposed along the periphery of the first shaft 1, or the connecting element 5. The axial spacing between a first row 8 and a second row 9 is therefore constant along the periphery of the first shaft 1 or the connecting element 5. Individual form-locking elements of the rows 8, 9 or individual rows 8, 9 can be implemented somewhat longer axially than the remaining form-locking elements, or rows 8, 9. This avoids the tendency toward “tooth-on-tooth positions” of the two rows 8, 9 of form-locking elements. Alternatively or additionally, all, individual or a few of form-locking elements of the rows 8, 9 can also form tips at an axial face side, which also reduces the tendency toward “tooth-on-tooth positions”.

In the example case shown, the first rows 8 are disposed radially inside the connecting element 5, and the second rows 9 are disposed radially outside on the first shaft 1. In the context of the invention, the rows 8 can also be alternatively disposed radially outside on the connecting element 5, and the corresponding rows 9 are accordingly disposed radially inside the first shaft 1. The rows of form-locking elements 8, 9 are designed such that using these, a torque transmission occurs, or is possible, between the first shaft 2 and the connecting element 5—when the connecting element 5 is located in the first axial position A. Here, the first rows 8 of form-locking elements are spaced axially so that, axially, a second row 9 of form-locking elements is located between at least two, preferably between each, of the first rows 8, when the connecting element takes on the second axial position B shown in FIG. 1. Accordingly, in the second axial position B, a first row 8 is also disposed axially between at least two of the second rows 9. The rows 8, 9 of form-locking elements, in the second axial position B, are not in engagement with each other, whereby a form lock is released between connecting element 5 and a first shaft 1.

It is clear that the connection between connecting element 5 and second shaft 2 can also be implemented analogously to the releasable form-locking connection of the connecting element 5 to the first shaft 1. In this case, the connecting element 5 has additional first rows of axially spaced form-locking elements, which interact with second rows of form-locking elements of the second shaft 2 such that these are form locked with each other when the connecting element 5 is located in the first axial position A (whereby the shafts 1, 2 are coupled), and are not form locked, when the connecting element 5 is located in the second axial position B (whereby the shafts 1, 2 are decoupled).

The function of the connecting device shown in FIGS. 1 and 2 is as follows:

As explained, FIG. 1 shows the connecting device in the decoupled state, that is, there is no form lock between the first and second shaft 1, 2, and thus no torque transmission occurs, or is possible, between the first and second shaft 1, 2. To allow torque transmission between the first and second shaft 1, 2, the connecting element 5 is moved axially from the second axial position B into the first axial position A. In doing so, the first and second rows 8, 9 of form-locking elements become form locked. In detail, each of the first rows 8 enters into form-locking contact with the respectively corresponding second row 9. Because the connecting element 5 is already in torque transmitting contact with the second shaft 2 via the form-locking elements 6, 7, then, with the axial movement of the connecting element 5 into the first axial position A, the final form lock is produced between the first and second shaft 1, 2 by the rows 8, 9 of form-locking elements. Thus it is possible to transmit torque between the two shafts 1, 2.

In the case shown, with the movement of the connecting element 5 into the first axial position A, the distance between the anchor element 10 and actuator 4 is maximized. Thus, this movement of the connecting element 5 can be caused either by producing a repelling effect between anchor element 10 and actuator 4, or particularly due to another means not shown. These means can utilize gravitational force, for example, in that the connecting element 5 itself, or a weight arrangement, which is suitably connected to the connecting element 5, is pulled in the direction of the earth's surface due to gravity. In the latter case, the connecting device is aligned accordingly with respect to the earth's surface. However, the means can also be a spring arrangement, which exerts a spring force on the connecting element 5 itself or on the anchor arrangement 10. This spring force is then used for the axial movement of the connecting element 5 into the first axial position A.

When the connecting element 5 is located in the first axial position A, shown in FIG. 2, in which the shafts 1, 2 are coupled together, and if this coupling is to be released, then the connecting element 5 is moved into the second axial position B. As a result, the engaged rows 8, 9 of form-locking elements are again disengaged, that is, they are released from each other corresponding to FIG. 1. This axial movement preferably occurs by means of the actuator 4 that generates a magnetic field, due to being electrically energized, which magnetically attracts the anchor element 10, whereupon the anchor element 10 is moved toward the actuator 4, thus in the direction of minimal distance to the actuator 4. This axial movement of the anchor element 10 is transmitted via the axial bearing 11 to the connecting element 5, which is correspondingly moved axially from the first into the second axial position A, B.

The movement of the displacement element 5 out of the first axial position A into the second axial position B (decoupling the shafts 1, 2) can be understood as an outward movement, and the movement of the displacement element 5 out of the second axial position B into the first axial position A (coupling the shafts 1, 2) can be understood as a return movement. Depending on the implementation of the actuator 4 and the anchor element 10, either the outward movement or the return movement can occur magnetically using these components 4, 10. The axial movement in the respectively opposing direction, that is, the return movement or the outward movement, then occurs by the other means, for example utilizing gravity or a spring arrangement. If the anchor element has one or more permanent magnets, the outward, as well as the return, movement can occur using the anchor element 10 and the actuator 4. Then, the polarity of the electrical energizing of the actuator 4 determines whether the magnetic field generated in doing so, acts to attract or repel the anchor element 10, and thus in the direction in which the connecting element 5 is to be moved.

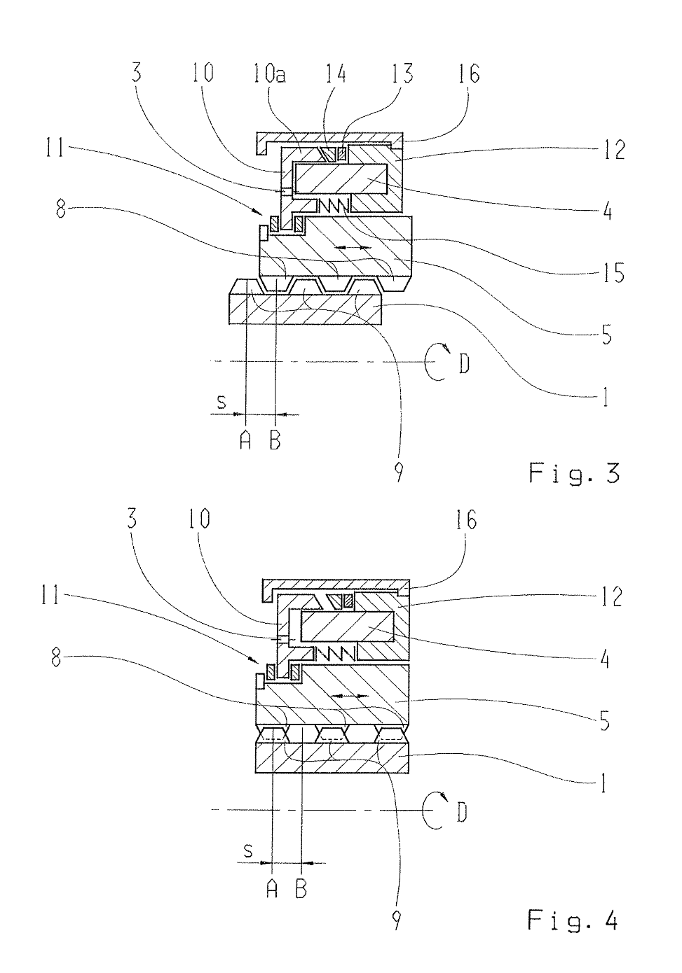

FIGS. 3 and 4 show a more detailed embodiment of the connecting device shown in FIGS. 1 and 2. Analogous to FIGS. 1 and 2, in each case, the lower half is not shown, for purposes of clarity. The same, or at least functionally equivalent, components are provided with the same reference numbers. For clarity, the second shaft and the connection of the connecting elements to this second shaft are not shown. The connecting element 5 can however be connected to the second shaft, according to the explanation above for FIGS. 1 and 2.

The further developments shown in FIGS. 3 and 4 relate substantially to the components surrounding the actuator 4. The actuator 4, the connecting element 5, the first and second rows of form-locking elements 8, 9, the anchor element 10 and the axial bearing 11 have the same function as in FIGS. 1 and 2, and can also be implemented or disposed accordingly in the alternatives named there.

According to FIGS. 3 and 4, the anchor element 10 is implemented such that it surrounds the actuator 4 at least partially. In detail, a first face side, a part of a radially outer side and part of a radially inner side of the actuator 4 are surrounded by the anchor element 10, when the connecting element 5 is located in the first and second axial position A, B. Furthermore, a magnetic yoke 12 is provided that surrounds a second face side of the actuator 4, located opposite the first face side, and a part of the radially outer and a part of the radially inner side of the actuator 4. The magnetic yoke 12 preferably lies directly against the actuator 4, in order to minimize an (air) gap between the actuator 4 and magnetic yoke 12. The anchor element 10 and magnetic yoke 12 each have a ring shape and are disposed coaxially to the axis of rotation D. This allows a very compact design in the axial direction of the connecting element. Due to the enclosure of the actuator 4 by the anchor element 10 and the magnetic yoke 12, the magnetic field of the actuator 4 can be purposefully directed, and thus, better utilized for moving the anchor element 10. The magnetic yoke 12 is rigidly connected to the actuator 4. A part of the magnetic yoke 12, particularly the part which surrounds the actuator 4 radially inside, preferably serves as a guide for the connecting element 5.

A permanent magnet 13 is disposed radially outside with respect to the actuator 4 and axially between the anchor element 10 and the magnetic yoke. Naturally, several permanent magnets 13 can also be provided there. The permanent magnet 13 shaped as a ring, is disposed surrounding the actuator 4. A currentless retaining function of the anchor element 10, and thus the connecting element 5, is implemented by the magnet. This means that the anchor element 10, and thus the connecting element 5, can be held in the position shown in FIG. 3, without needing to electrically energize the actuator 4. This is based on the fact that the permanent magnet 13 magnetically retains the anchor element 10, when the connecting element 5 is in the second axial position B, as shown in FIG. 3. The permanent magnet 13 can also be embedded in the magnetic yoke 12, for example by injecting or bonding. Thus undesired loosening of the permanent magnet 13 is prevented. The permanent magnet 13 is disposed with respect to the magnetic yoke 12 such that a magnetic flux axis of the permanent magnet 13, that is, the axis along which the magnetic flux lines thereof run, corresponds substantially to a magnetic flux axis of the actuator 4 in the range of the permanent magnets 14, when the actuator is appropriately energized. The permanent magnet 13 can either be fixed in location with respect to the anchor element 10 (and then is moved with it), or fixed in location with respect to the magnetic yoke 12. In FIGS. 3 and 4, the magnet is fixed in location to the magnetic yoke 12.

In the embodiment according to FIGS. 3 and 4, a ring-shaped stop element 14 is disposed axially between the permanent magnet 13 and the anchor element 10, and also radially outside with respect to the actuator 4. If the permanent magnet 13 is disposed, fixed in location with respect to the anchor element 10, the stop element 14 is then located axially between permanent magnet 13 and the magnetic yoke 12. In both embodiments, the stop element 14 is fixed in location with respect to the permanent magnet 13, for example in that both are rigidly connected together. The stop element 14, according to FIGS. 3 and 4, comes into contact with an edge 10a of the anchor element 10, when the connecting element 5 is located in the second axial position B. It serves for transmitting the magnetic field of the permanent magnet 13 and/or the actuator 4 to the anchor element 10. Additionally, it prevents the anchor element 10 from directly striking against the permanent magnet 13 in order to prevent damage thereof. A side of the stop element 14 facing toward the anchor element 10, specifically, at the edge 10a of the anchor element 10, is slanted, and thus forms a conical surface. This corresponds to a conical surface of the edge 10a of the anchor element 10. This results in enlarging the contact surface between stop element 14 and anchor element 10. Additionally, impacting of the anchor element 10 against the stop element 14 is diminished due to the conical surface.

The permanent magnet 13 and/or the stop element 14 can also be disposed at another suitable location, particularly radially inside with respect to the actuator 4. Due to the radial placement of the permanent magnet 13 and/or stop element 14 with respect to the actuator 4, the required construction space in the axial direction for the connecting element 5 is very small.

A spring arrangement 15 is disposed radially inside with respect to the actuator 4, and axially between the magnetic yoke 12 and anchor element 10. This causes an axially acting spring force between the anchor element 10 and the magnetic yoke 12. The direction of the spring force, in the case shown in FIGS. 3 and 4, is such that the connecting element is pushed, induced by spring force, out of the second axial position B into the first axial position A. In other words, the spring arrangement 15 is implemented so that it pushes the anchor element 10 away from the actuator 4. This spring force is transmitted from the anchor element 10 via the axial bearing 11 to the connecting element 5. With this, a return movement of the connecting element 5 out of the second axial position B (FIG. 3) into the first axial position A (FIG. 4) is possible without energizing the actuator 4. The movement out of the first axial position A into the axial second position B occurs, in contrast, due to energizing the actuator 4, and with the aid of the anchor element 10. Any suitable means that absorbs potential energy due to elastic deformation during the outward movement, and can again substantially release this energy for creating the return movement, can be used for implementing the spring arrangement 15. The spring arrangement 15 can be comprised for example of one or more disk springs, coil springs, wave springs, elastic elements, foam elements, etc. The spring arrangement 15 is particularly guided radially in a recess of the magnetic yoke 12 and/or the anchor element 10, in order to prevent slipping radially.

It is noted that the spring arrangement 15 can also be disposed at another suitable location, particularly radially outside with respect to the actuator 4. Depending on the selected installation location, and whether it causes the outward or return movement of the connecting element 5, the spring arrangement can be designed to exert either a pulling force or a pushing force on the anchor element 10 or the connecting element 5. The position of the edge 10a, the stop element 14 and the permanent magnet 13 can also be exchanged with the position of the spring arrangement 15. Thus, the spring arrangement 15 would be located at the position at which the edge 10a, the stop element 14 and the permanent magnet 13 are disposed in FIGS. 3 and 4, while these would be located at the position at which the spring arrangement 15 is located in FIGS. 3 and 4.

The permanent magnet 13 must be designed to be at least strong enough for the currentless retaining function that retains the anchor element 10 against the spring force of the spring arrangement 14, after the actuator 4 has moved the anchor element 10 into the corresponding axial position A, B. According to FIGS. 3 and 4, this is the case when a minimal spacing exists between the permanent magnet 13 and the anchor element 10. The actuator 4 then also has a minimal spacing to the anchor element 10. Here, the connecting element 5 is located in the second axial position B. In the decoupled state of the connecting device shown in FIG. 3, the connecting device is therefore particularly currentless, that is, the actuator 4 is not electrically energized. The spring arrangement 15 is maximally tensioned in this state. For moving the anchor element 10, and therefore the connecting element, out of the second axial position B (FIG. 3) into the first axial position (FIG. 4), the actuator 4 is energized, particularly the polarity and strength is selected such that the magnetic field of the permanent magnet 13 is sufficiently strongly attenuated until the spring force of the spring arrangement 15 acting on the anchor element 10 overcomes the retaining force of the permanent magnet 13 on the anchor element 10. Thereby, the anchor element 10, and subsequently also the connecting element 5, begin to move out the second axial position B in the direction of the first axial position A. The range of the retaining force of the permanent magnets 13 is selected to be very weak, for example 1/10 of the entire path S, whereby the energization of the actuator 4 can be terminated early, as soon as the anchor element 10 has moved out of this range. As a result, the energy consumption of the connecting device can be minimized. The spring force of the spring arrangement 15 causes the anchor element 10 and the connecting element 5 to move further into the first axial position A, wherein, in the course of this movement, the first rows 8 of form-locking elements come into engagement with the second rows 9 of form-locking elements, and the shafts 1, 2 are coupled together and can transmit torque. In the end position shown in FIG. 4, the anchor element 10 and permanent magnet 13 are maximally distanced from the actuator 4. Additionally, the spring arrangement 15 is completely relaxed.

For releasing the connection of the first and second shaft 1, 2, the actuator is energized again, preferably such that in the range of the permanent magnet 13, the magnetic field generated by the actuator 4 is aligned in the same direction as the magnetic field generated by the permanent magnet 13. This increases the range of the actuator 4. The anchor element 10 experiences a magnetic attraction and begins to move, counter to the spring force of the spring arrangement 15, toward the actuator 4. The spring arrangement 15 is tensioned during this movement, and the first and second rows 8, 9 of form-locking elements are released from each other, that is, are disengaged. As a result, the shafts 1, 2 are also released from each other—thus they can rotate freely with respect to each other, and the connecting device is now located in the decoupled state. As soon as the anchor element 10 has reached the minimal distance to the actuator 4 and the permanent magnet 13—the connecting element 5 is then located in the second axial position B—the energizing of the actuator 4 can be discontinued because the anchor element 10, specifically the edge 10a of the anchor element 10, is located in the range of the permanent magnet 13, such that the magnet retains the anchor element 10 against the spring force of the spring arrangement 15. Thus, the connecting device is bistable, that is, it does not need to be electrically energized, either in the coupled state (FIG. 4) or in the decoupled state (FIG. 3), in order to properly maintain the respective state.

The connecting device shown in FIGS. 3 and 4, also has a housing 16 which forms a radial outer wall of the connecting device. The housing 16 also surrounds a part of the two axial face sides of the connecting device. Here, it shields the components, 4, 5, 8, 10, 11, 12, 13, 14, 15 of the connecting device from external influences (mechanical, magnetic). It also supports the spring force of the spring arrangement 15 acting between the anchor element 10 and the magnetic yoke 12. Thus, the housing 16 contains the essential components of the connecting device and fixes the components in place with respect to each other. The forces occurring within the connecting device are supported by the connecting device itself. Due to this, the connecting device can be prefabricated as a complete module, and later at the installation site only needs to be added/inserted into the installation space provided therefor, without further assembly steps being required for the connecting device.

One or more specific outlet openings 3 can be provided to allow draining of fluids during actuation of the connecting device, that is, during the movement of the anchor element 10 and the connecting element 5. This is particularly advantageous with the arrangement of the connecting device in a high viscosity fluid, for example hydraulic oil or transmission oil, whereby the movement is less strongly damped and the connecting device reacts faster. In particular, one or more outlet openings 3 are provided to allow drainage of fluid between the anchor element 10 and actuator 4. In the case shown in FIGS. 3 and 4, this opening 3 is located in the anchor element 10. The opening 3 can alternatively or additionally be located at another site, particularly in the magnetic yoke 12.

It is noted that, in principle, all suitable means can be used as form-locking elements 6, 7, 8, 9, for example pins, claws, teeth, polygon profiles etc. In principle, also a synchronization device, such as a synchronizing ring known from vehicle shift transmissions, etc. can be disposed between one, several, or all of the rows 8, 9 of form-locking elements. Thereby, rotational speed equalization is possible between the first shaft 1 and connecting element 5, before the final form lock is produced between the components 1, 5.

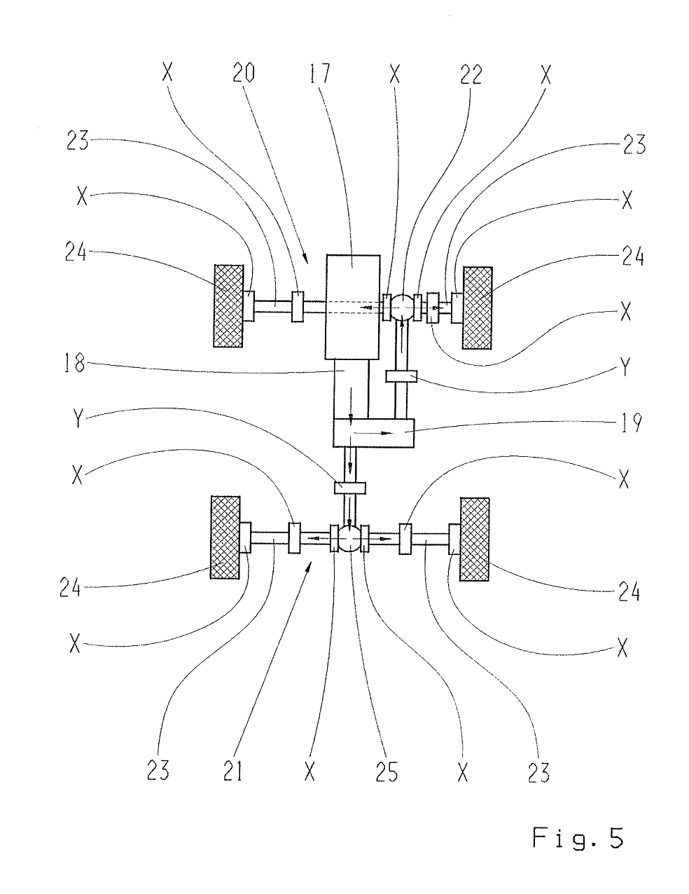

FIG. 5 shows a vehicle drive train in a top view. The connecting device, described above, is used, particularly preferably, in such a drive train due to small amount of installation space required, i.e. in one/more of the gearings (18, 19, 22, 25) of the drive train.

The drive train shown in FIG. 5 is an all-wheel vehicle drive train, also called a 4WD or AWD drive train. The drive train has a drive motor 17, for example an internal combustion engine, an electric motor or an internal combustion engine-electrical motor hybrid drive. A conventional gear shifting transmission 18, for example an automatic transmission or a manual/automated shift transmission or continuously variable transmission, is attached on the output side to the drive engine 17. A separating clutch, not shown here, can be located in terms of drive technology between drive engine 17 and gear shifting transmission 18, that is, a startup clutch. The drive engine 17 and the gear shifting transmission 18 are implemented here in the front-longitudinal arrangement; other arrangements are however also conceivable, for example a front-transverse arrangement or a center mounted engine arrangement.

Within the gear shifting transmission 18, one of several transmission ratios is engaged, generally depending on the driving situation, in order to increase or decrease the torque provided by the drive engine 17. The drive train has flanged directly to the gear shifting transmission 18, a first distributor transmission 19, specifically a longitudinal distributor transmission, which distributes the output torque of the gear shifting transmission 18 to a front axle 20 and a rear axle 21 (according to the depicted arrows). Here, the first distributor transmission 19 can have integrated at least one of the connecting devices according to the invention, in order to couple or decouple, in terms of drive technology, the front axle 20 and/or the rear axle 21 from the gear shifting transmission 18. Hereby, selectively no torque, or maximum possible torque, can be transmitted to the respective axle 20, 21.

Alternatively or additionally, one or more connecting devices can be disposed between the first distributor transmission 19 and the front axle and/or rear axle 20, 21, using these devices, the respective axles 20, 21 can be decoupled and coupled to the distributor transmission 19—example installation sites are indicated here with the referenced symbol Y. Naturally, the connecting device can also be used within the gear shifting transmission 18.

Starting from the first distributor transmission 19, the torque allocated to the front axle 20 is transmitted to a second distributor transmission 22, here a transverse distributor transmission, where the torque in turn is distributed to a right and left wheel drive shaft 23 (also called side shafts or wheel shafts), and from there to a right or left vehicle wheel 24 (according to the depicted arrows). Analogous to the front axle 20, torque is also transmitted to the vehicle wheels 24 of the rear axle 21, which for this purpose has a third distributor transmission 25.

In particular, if the second and/or the third distributor transmission 22, 25 are implemented as slip differential transmissions or for coupling and decoupling one of the wheel drive shafts 23, these can have at least one of the connecting devices according to the invention integrated therein, in order to couple or decouple the respective wheel 24, in terms of drive technology, from the remaining vehicle drive train. Alternatively or additionally, one or more of the connecting devices can also be disposed between one of the vehicle wheels 24 and the associated distributor transmission 22, 25, at or in the respective wheel drive shaft 23—example installation sites for this are indicated with the reference symbol X.

The drive train represented here is an example and should not be considered as limiting for the invention. It is obvious to the person skilled in the art that the drive train can also be implemented such that only the front axle or the rear axle 20, 21 can be driven by the drive engine 17, that is, the vehicle drive train can also be a so-called 2WD drive train. The use of the connecting device according to the invention is also not limited to multi-track vehicles, but, rather, can also be used with single track vehicles, for example a motorcycle or a scooter or similar. The vehicle drive train can also have more than two driven axles and for example can be implemented as a 6×6 or 8×8 drive train, that is, having 3 or 4 drivable axles.

### REFERENCE CHARACTERS

1 first shaft
2 second shaft
3 discharge opening
4 electromagnetic actuator
5 connecting element
6 form-locking element
7 form-locking element
8 first row of form-locking elements
9 second row of form-locking elements
10 anchor element
11 axial bearing
12 magnetic yoke
13 permanent magnet
14 stop element
15 spring arrangement
16 housing
17 drive motor
18 gear shifting transmission
19 first distributor gearing
20 front axle
21 rear axle
22 second distributor gearing
23 wheel drive shaft
24 vehicle wheel
25 third distributor gearing
A first axial position
B second axial position
S shift path
X installation location
Y installation location

1-15. (canceled)

16. A connecting device, for a vehicle drive train, for achieving a rotationally fixed connection between first and second shafts (1, 2) that are rotatable relative to each other, the connecting device comprising:
an axially movable connecting element (5) having form-locking elements (8, 9) which, in a first axial position (A), produce a form lock between the first and the second shafts (1, 2) via the form-locking elements (8, 9), and, in a second axial position (B), release the form lock;
an electromagnetic actuator (4) which, upon electrical energization, causing axial movement of the connecting element (5) between the first and the second axial positions (A, B);
the form-locking elements (8, 9) are disposed in a plurality of first rows (8), spaced from one another, in an axial direction of the connecting element such that:
in the first axial position (A), the first rows (8) are form locked with at least one corresponding second row (9) of form-locking elements of the first shaft (1) so that the form lock is produced between the first and the second shafts (1, 2), and
in the second axial position (B), the first rows (8) are released from the respective corresponding second row (9) of form-locking elements of the first shaft (1) so that the form lock is released between the first and the second shafts (1, 2).

17. The connecting device according to claim 18, wherein the electromagnetic actuator (4) and the connecting element (5) have a ring shape and are disposed coaxially to at least one of the first and the second shafts (1, 2), and the connecting element (5) is disposed at least partially radially within the electromagnetic actuator (4), and the first rows (8) of the form-locking elements are disposed radially within the connecting element (5).

18. The connecting device according to claim 16, further comprising an anchor element (10, 10a), which is magnetically movable by energizing the electromagnetic actuator (4), and which is rotatably connected to the connecting element (5), via an axial bearing (11), such that movement of the anchor element (10, 10a) causes the axial movement of the connecting element (5) between the first and the second axial positions (A, B).

19. The connecting element according to claim 16, further comprising an anchor element (10, 10a), which can be displaced magnetically by energizing the electromagnetic actuator (4), and which is fixedly connected at location to the connecting element (5) such that a displacement of the anchor element (10, 10a) causes the axial movement of the connecting element (5) between the first and the second axial positions (A, B).

20. The connecting device according to claim 18, wherein at least one of a magnetic yoke (12) is fixedly connected to the electromagnetic actuator (4) and envelops at least at a first portion of the electromagnetic actuator (4), and the anchor element (10, 10a) surrounds at least a second portion of the electromagnetic actuator (4).

21. The connecting device according to claim 20, wherein the magnetic yoke (12) and the anchor element (10, 10a) completely envelop the electromagnetic actuator (4) at least when the connecting element (5) is located in at least one of the first and the second axial positions (A, B).

22. The connecting device according to claim 20, wherein at least one of the magnetic yoke (12) and the anchor element (10, 10a) have at least one opening (3) through which drainage of fluid is possible out of envelopment of the actuator (4) formed by the magnetic yoke (12) and the anchor element (10, 10a).

23. The connecting device according to claim 18, wherein at least one permanent magnet (13) magnetically retains the anchor element (10, 10a), when the connecting element (5) is located in either the first or the second axial positions (A, B), and thus fixes the connecting element (5) in the respective first or the second axial position (A, B), the at least one permanent magnet (13) is disposed in a region of a magnetic yoke (12) of the connecting device such that, in an installation position region of the permanent magnet (13), a magnetic flux axis thereof corresponds to a greatest degree possible to a magnetic flux axis of the electromagnetic actuator (4), when the electromagnetic actuator is energized.

24. The connecting device according to claim 23, wherein the electromagnetic actuator (4) has a ring shape and the permanent magnet (13) is disposed either radially within or outside of the electromagnetic actuator (4).

25. The connecting device according to claim 20, wherein the electromagnetic actuator (4) is disposed to cause an outward movement of the connecting element (5) into either the first or the second axial position (A, B), and a spring arrangement (15) causes a return movement of the connecting element (5) into the other respective first or the second axial position (A, B).

26. The connecting device according to claim 25, wherein the connecting element (5), the electromagnetic actuator (4), the anchor element (10, 10a), the magnetic yoke (12) and the spring arrangement (15) are each shaped as a ring, and are disposed coaxially with respect to one another, and the spring arrangement (15) is disposed radially within the electromagnetic actuator (4), and the connecting element (5) is disposed radially within the spring arrangement (15), and the spring arrangement (15) is disposed axially between the anchor element (10, 10a) and the magnetic yoke (12).

27. The connecting device according to claim 16, wherein the connecting device comprises a housing (16), which encloses an outer periphery of the connecting device and at least a portion of a first face side and a second face side, located opposite thereto, of the connecting device.

28. A connecting device in combination with a transmission (18, 19, 22, 25) for a motor vehicle drive train having a first and a second shaft (1, 2) that are rotatable in the transmission, the connecting device connecting the first and the second shafts to one another in rotationally fixed manner, and the connecting device comprising:
an axially movable connecting element (5) having form-locking elements (8, 9) which, in a first axial position (A), produce a form lock between the first and the second shafts (1, 2) via the form-locking elements (8, 9), and, in a second axial position (B), release the form lock;
an electromagnetic actuator (4) which, upon electrical energization, causes axial movement of the connecting element (5) between the first and the second axial positions (A, B);
the form-locking elements (8, 9) are disposed in a plurality of first rows (8), spaced from one another, in an axial direction of the connecting element such that:
in the first axial position (A), the first rows (8) are form locked with at least one corresponding second row (9) of form-locking elements of the first shaft (1) so that the form lock is produced between the first and the second shafts (1, 2), and
in the second axial position (B), the first rows (8) are released from the respective corresponding second row (9) of form-locking elements of the first shaft (1) so that the form lock is released between the first and the second shafts (1, 2); and
the connecting element (5) and the second shaft (2) each having corresponding form-locking elements (6, 7) which are in continuous engagement with one another regardless of whether the connecting element (5) is in the first axial position (A) or the second axial position (B).

29. A method of actuating a connecting device of a vehicle drive train for connecting, in a rotationally fixed manner, first and second shafts that are rotatable relative to one another, the connecting device having an axially movable connecting element (5) with form-locking elements (8, 9) which, in a first axial position (A), produce a form lock between the first and the second shafts (1, 2) via the form-locking elements (8, 9), and, in a second axial position (B), release the form lock, an electromagnetic actuator (4) which, when electrically energized, causes axial movement of the connecting element (5) between the first and the second axial positions (A, B); the form-locking elements (8, 9) are disposed in a plurality of first rows (8), spaced from one another, in an axial direction of the connecting element such that, in the first axial position (A), the first rows (8) are form locked with at least one corresponding second row (9) of form-locking elements of the first shaft (1) so that the form lock is produced between the first and the second shafts (1, 2), and, in the second axial position (B), the first rows (8) are released from the respective corresponding second row (9) of the form-locking elements of the first shaft (1) so that the form lock is released between the first and the second shafts (1, 2), the method comprising the steps of:
electrically energizing the electromagnetic actuator (4) to move the connecting element (5) axially into one of the first or the second axial positions (A, B) until a permanent magnet (13) magnetically retains an anchor element (10, 10a), which is fixed to the connecting element, in the one of the first or the second axial positions (A, B), and the energizing occurs such that, in a range of the permanent magnet (13), a magnetic field of the electromagnetic actuator (4) is aligned in a same direction as a magnetic field of the permanent magnet (13); and
energizing the electromagnetic actuator (4) for an axial return movement of the connecting element (5) into the other of the first or the second axial positions (A, B) until the anchor element (10, 10a) is released from the magnetic retention of the permanent magnet (13), and, in doing so, the energizing occurs such that the magnetic field of the electromagnetic actuator (4), in the range of the permanent magnet (13), is directed counter to the magnetic field of the permanent magnet (13), and the energizing is strong enough so that, in the range of the permanent magnet (13), the magnetic field of the electromagnetic actuator (4) at least substantially cancels out the magnetic field of the permanent magnet (13).

30. The method according to claim 29, further comprising the step of inducing the axial return movement of the connecting element (5), by spring force, into the other of the first axial position or the second axial position (A, B).
